(19) United States
(12) Patent Application Publication
(10) Pub. No.: US 2011/0070327 A1
(43) Pub. Date: Mar. 24, 2011

(54) Use of High-Oleic Distillers Grains in Animal Feed to Improve Animal Product Quality

(75) Inventors: Fred R. Wolf, Urbandale, IA (US); Fredric N. Owens, West Des Moines, IA (US); Cindi S. Zimmermann, Madrid, IA (US)

(73) Assignee: Pioneer Hi-Bred International, Inc.

(21) Appl. No.: 12/874,298

(22) Filed: Sep. 2, 2010

Related U.S. Application Data
(60) Provisional application No. 61/244,475, filed on Sep. 22, 2009.

(51) Int. Cl. A23K 1/06; A23K 1/18

(52) U.S. Cl. 426/2; 426/624

(57) ABSTRACT

A novel method for improving the meat, milk, and egg quality of livestock is provided. In one embodiment, the method comprises feeding the animal a diet supplemented with oleic acid and distillers grains. The source of the oleic acid may be distillers grain from high-oleic corn. The method improves the quality of meat from both non-ruminants and ruminants.

### CROSS REFERENCE TO RELATED APPLICATIONS

This application claims the benefit of U.S. Application Ser. No. 61/244,475 filed Sep. 22, 2009, herein incorporated by reference.

### FIELD OF THE INVENTION

This patent relates to a method of improving meat, milk, and egg quality. More specifically, this patent relates to a method of improving animal product quality by feeding a diet including effective amounts of high-oleic distillers grains in various forms to improve meat oxidative stability and carcass and milk quality over those from animals fed diets containing high levels of commodity distillers grains.

### BACKGROUND OF THE INVENTION

The growth of the dry grind ethanol industry has created an abundance of distillers grains (DG) in the marketplace. It is estimated that for every bushel of corn processed into ethanol, 17 pounds of DG is created as a co-product. Distillers grains have three times the protein, fat, vitamin, and mineral content of corn, making it an attractive, economical supplement to poultry and livestock diets.

However, use of commodity DG in livestock and poultry diets is limited by several compositional disadvantages. One of these is the abundance of linoleic acid (C18:2) relative to other fatty acids that are more saturated such as oleic acid. The high concentration of linoleic acid in commodity DG creates meat quality problems when fed to animals due to its limited oxidative stability (OS) and low melting point (MP). From a practical standpoint, meat, milk, and eggs derived from animals fed diets containing high concentrations of commodity DG tend to exhibit reduced shelf life (due to low OS), and reduced carcass firmness results in reduced processing efficiency of product handling and storage.

There are currently no clear solutions to these low OS or processing efficiency problems. There is the potential to address the OS issue by addition of antioxidants to the diet, although the benefits of this have not yet been unequivocally demonstrated. Further, the addition of antioxidants—including supranutritional levels of alpha-tocopherol acetate—would add significant cost to the diet.

The present invention is unique because it offers a single cost-effective solution to both the OS and carcass quality problems currently limiting the use of commodity DG. In addition, it allows producers to feed larger amounts of this relatively inexpensive and abundant co-product to reduce feed costs. High-oleic distillers grain (HODG) when derived from high-oleic corn, can offer several other potential advantages, including improved initial DG quality and storage stability as a result of undergoing less degradation during processing. Specific quality attributes of this product include less degradation of fatty acids. Another advantage is that supranutritional levels of antioxidants such as alpha-tocopherol acetate (ATA) may be added to the product that provides a degree of OS that is not achievable with a combination of commodity DG and ATA. This capability would be useful for products with acute OS-related quality and shelf life issues such as precooked meats.

### BRIEF DESCRIPTION OF THE DRAWINGS

FIG. 1 depicts a comparison of TBARs concentrations in freshly cooked and warmed over breast meat after 24 hours.

FIG. 2 depicts a comparison of TBARs concentrations in freshly cooked and warmed over thigh meat after 24 hours.

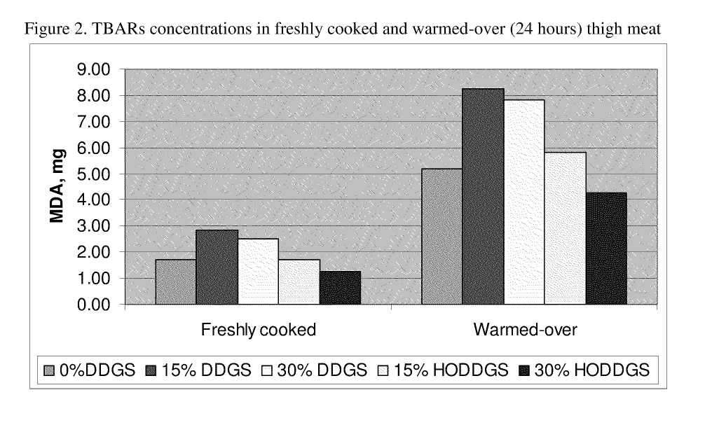

FIG. 3 depicts the effect of dietary treatments on Iodine Values in various tissues.

### DETAILED DESCRIPTION OF THE INVENTION

The oxidative stability of raw meat and cooked meat products is of great economic importance to the livestock and meat processing industries. At present, freezing, antioxidant supplementation, or vacuum and/or modified atmosphere packaging (MAPS) are the primary methods for deterring oxidative deterioration of cooked meat products. However, these methods—whether used alone or in combination—do not necessarily provide adequate product quality or shelf life. Cooked meat products in particular are vulnerable to the development of warmed over flavor (WOF) that is largely a consequence of lipid oxidation. This deterioration can result in the development of off-flavors that render the product unpalatable and unsellable.

The invention entails the feeding of high-oleic distillers grains (HODG) in its various forms to livestock and poultry to improve carcass quality and meat oxidative stability (OS). Oleic acid (C18:1) should comprise at least 50% and preferable about 55, 60, 65, 70, 75, or 80% or more by weight of the total fatty acid fraction of the DG.

Fermentation feedstocks include HO corn and other HO feedstocks suitable for ethanol production.

In another aspect, the invention comprises the addition of high-oleic oils to a livestock diet including commodity DG.

Because oleic acid is less prone to oxidation than polyunsaturated fatty acids, the oxidative stability of the meat tissue and milk is increased. This compositional change improves the shelf life of fresh and precooked meat products and milk. It is anticipated that HO DG will also improve the oxidative stability of eggs, and their derivative products. It is also anticipated that the addition of antioxidants—in particular tocols in the form of alpha-tocopherol acetate (ATA), gamma-tocopherol (GT), tocotrienols (T3) and mixtures thereof—will enhance the described benefits.

A further advantage of HODG is that it may be fed to livestock and poultry to improve carcass firmness and thereby improve processing efficiency, which is of particular importance for bacon from meat cuts with high-fat content (e.g., pork bellies). Carcass firmness can be measured using the method of Rentfrow G., et al. 2003. Meat Science, 64:459-466.

A further advantage relative to commodity DG, is that HODG can increase fiber digestion by ruminal microbes when fed to ruminant animals that in turn, will permit higher relative amounts of DG to be fed without depressing net energy intake.

It is anticipated that the diet of the invention can also improve the quality of non-edible animal products such as fiber and hide. For the purposes of the present invention, “animal products” will refer to generally edible animal products such as, but not limited to, meat, milk, and eggs.

Currently, swine can be fed diets that include up to 10-15% commodity DDGS (dry matter weight) without adversely impacting carcass or meat quality. (See Xu, G. et al. 2007, J. Anim. Sci. 85 (Suppl. 2):76 (Abst. 104) and Widmer, M. R., et al. 2008. J. Amin. Sci. 86:1819-1831).

Poultry can be fed up to 8% DDGS (dry matter weight) without adverse impact on carcass or meat quality. (See Corzo, A., et al. 2009. Poultry Sci. 88:432-439).

Recommended dietary inclusion levels for cattle (beef and dairy) are from 10% to about 20% DDGS (dry matter weight) without adverse impact on carcass or meat quality or dairy oxidative stability. (NCGA Bulletin, Jan. 9)

One primary indicator of meat quality is oxidative stability (as measured by the concentration of thiobarbituric acid reactive substances—TBARs—in the meat). Oxidation of the myoglobin pigment and fatty acids can result in color degradation and off-flavors in the meat products. Similarly, formation of lipid hydroperoxides and hexanal in milk exposed to light can be used to monitor susceptibility to formation of off-flavors in milk.

The oxidative stability of meat products is of importance with respect to retail shelf life. Oxidative color deterioration in fresh beef, for example, has been estimated to cost U.S. retailers over $1 billion per year due to discounted and discarded product. (Feed Management, July 1995, Vol. 46(7))

Extending shelf life of milk also would have a substantial economic benefit for milk marketing and be appealing for consumers.

The present invention is a novel method for improving the quality of an animal product, the method comprising feeding the animal a diet including HODG derived from high-oleic corn or commodity corn DG plus high-oleic oil in amounts effective to improve the animal product quality.

The operable dietary range is at least about 5% by dry weight HODDGS to about 40% by dry weight HODDGS; a preferred dietary range is from at least about 10% to about 30% by dry weight HODDGS, an optimal dietary range is from at least about 10% to 15% by dry weight HODDGS.

To obtain benefits in product quality, the HODG diet can be fed to the animal for at least 30 days for swine, at least 50 days for meat-producing cattle, for 14 days for milk-producing cattle, and for at least 20 days for poultry. However, no adverse effects from feeding the product for longer time periods is expected.

The HO trait may be achieved through conventional breeding methods or genetic engineering (e.g., FAD2 co-suppression see U.S. Pat. No. 6,372,965). Previous research with HO corn and HO mock-up diets has shown that HO diets increase the relative amount of oleic acid (C18:1) in fat and lean (muscle) tissue, typically at the expense of polyunsaturated fatty acids such as linoleic acid (C18:2).

The increase in oleic acid in the diet can be achieved by the addition of high-oleic vegetable oils, including, but not limited to: high-oleic corn, sunflower, canola, or soy oil. High-oleic corn can also be added to the diet to achieve the desired levels of oleic acid.

The animal may be a non-ruminant/monogastric, including, but not limited to: poultry, swine, or fish; or a ruminant, such as, but not limited to, cattle, bison, goat, or sheep. Poultry includes, but is not limited to, chicken and turkey.

In the examples that follow, meat tissue quality is measured using a number of parameters, including color score, pH, percent discolorization and oxidative stability (TBARS level) and milk quality is measured by accumulation of hydroperoxides. The TBARS method has been proven effective with meat from poultry and other non-ruminants/mongastrics as well as ruminants, whereas hydroperoxide accumulation is a routine measurement of milk stability. The improved tissue may comprise any animal tissue, and includes, but is not limited to, muscle meat, organs, milk and eggs. Meat color can be scored using the method found in the Proceedings of the Reciprocal Meat Conference. 1991. American Meat Science Association, Savoy, Ill. Meat pH can be measured using the method of Karlsson, A. & Rosenvold, K. 2002. Meat Science, 62:497-501.

### DEFINITIONS

Throughout this patent application a number of terms and abbreviations are used. The following definitions are provided to assist the reader:

Control (CO) refers to a control dietary treatment.

High-oleic (HO) trait: a trait wherein a genetically modified oilseed or grain exhibits a greater than wild-type level of oleic fatty acid. See WO Pub. 94/11516, WO Pub. 90/10380, WO Pub. 91/11906, and U.S. Pat. No. 4,627,192.

Thiobarbituric acid reactive substances (TBARS): TBARS concentration in meat is used as a measure of the extent of oxidation. There is a positive correlation between TBARS values and extent of oxidation.

Malonaldehyde (MDA): a TBARs analyte found in many foodstuffs and often used in research as a measure of rancidity (oxidative stability). There is a positive correlation between MDA values and extent of oxidation.

Hydroperoxide and hexanal: Fat oxidation products that accumulate in milk during oxidation. There is a positive correlation between these compounds and extent of oxidation and presence of off-flavors of milk.

Iodine Value (IV): a value predictive of carcass quality, found by determining the fatty acid profile of a sample and calculated as follows: IV=(% C16:1*0.950)+(% C18:1*0.860)+(% C18:2*1.732)+(% C20:1*0.785)+(% C22:1*0.723). An IV over 70 predicts soft fat and low carcass quality. (see also M. A. Latour and A. P. Schinckel, Dept of Animal Sciences, Purdue University, Extension Bulletin ID-345-W)

Distiller's grains (DG): Grain fraction co-product of dry grind ethanol process; generic term that can include DDG, DDGS, and WDG (see below). For the purposes of the invention, ‘DG’ is used generically, and ‘DDG’ or ‘DDGS’ in those instances where more precise measurements are given.

Distiller's dried grain (DDG): Dried coarse grain fraction remaining after removing ethyl alcohol from yeast fermentation. After corn kernels are ground, starch molecules are converted into sugar and fermented into ethanol. The resulting co-product can contain concentrated nutrients by a factor of three as compared to corn.

Distillers dried grains with solubles (DDGS): DDG that has been blended with condensed distillers solubles syrup and dried to provide increased shelf life and improved handling.

Wet distiller's grains (WDG): Wet feed source that may be economical to operations within about 100 miles of an ethanol plant. WDG may be blended with corn silage, soyhulls, beet pulp, etc. It is often economically priced.

Oleic Acid (OA): A monounsaturated omega-9 fatty acid designated C18:1 found in the fatty acid profile of various animals and plant sources, particularly grains and oil seeds. Oleic acid is less prone to oxidation than polyunsaturated fatty acids such as linoleic acid.

High-Oleic (HO) grain: Grain containing over 60% by weight of oleic acid in a total fatty acid profile.

Warmed-Over Flavor (WOF): Warmed-over flavor (WOF), also called meat flavor deterioration (MFD) is an adverse sensory perception that can occur in pre-cooked meat products. As a result of autoxidation, meat loses its fresh-cooked flavor and develops rancid off-odors and flavors.

Purge: The liquid that accumulates in packaging from a cut of meat. Purge (sometimes referred to as “drip loss”) is unattractive to consumers and is addressed by retailers through use of absorbant pads, drainage trays or other apparatus, hydrolyzed gelatin coating, or other methods. Often packaged meat with excess purge is disposed of before its shelf-life expiration date. Reducing purge would result in significant cost savings for retailers of pre-packaged meat products. (See: Otto, G, et al. 2004. Meat Science, 68:401-409)

The present invention is further defined by the following examples. The examples, while indicating particular embodiments of the invention, are given by way of illustration only. From the discussion contained herein and the examples themselves, one skilled in the art can ascertain the essential characteristics of the invention and, without departing from the scope thereof, make changes and modifications to the invention to adapt it to various situations and conditions.

### Example 1

### DDGS Preparation

Commodity DDGS material was shipped to the TAMU Food Protein Research and Development Center (College Station, Tex.) where it was processed to reduce its oil content. The material underwent hexane extraction at 125° F. for one-hour, followed by air-drying; initial analysis showed a reduction in residual oil content from 10.45% to 1.48%. The extracted DDGS material was shipped back to Pioneer for use in diet preparation. A sample of extracted DDGS, along with basal corn and soybean meal samples, was collected and submitted for determination of moisture, protein, fat (ether extract), gross energy (GE), crude fiber, ash, calcium, phosphorus, and amino acid profile (Table 1). Corn and high-oleic sunflower oil sources were sampled and submitted for GE and fatty acid analyses; a sample of extracted DDGS was also submitted for fatty acid analysis (Table 2).

TABLE 1
Analyzed nutrient composition of ingredient sources used to prepare diets

| | As-Is-Basis | | | | | Dry Matter Basis | | | | |
|---|---|---|---|---|---|---|---|---|---|---|
| | | | | Corn | HOS | | | | Corn | HOS |
| | Basal | Soybean | Extracted | Oil | Oil | Basal | Soybean | Extracted | Oil | Oil |
| Nutrient | Corn | Meal | DDGS | DDGS¹ | DDGS¹ | Corn | Meal | DDGS | DDGS¹ | DDGS¹ |
| Lot ID | F07CN- | SBM05- | DDGS- | — | — | — | — | — | — | — |
| | KL-01 | ERH-01 | TAMU-01 | | | | | | | |
| Moisture, % | 14.5 | 12.0 | 12.8 | 10.0 | 9.8 | — | — | — | — | — |
| Protein, % | 6.7 | 47.4 | 29.0 | — | — | 7.9 | 53.9 | 33.3 | — | — |
| Fat, % | 3.4 | 1.6 | 3.3 | 10.8 | 10.9 | 4.0 | 1.8 | 3.8 | 12.0 | 12.1 |
| GE, cal/g | 3844 | 4112 | 4395 | 4747 | 4746 | 4497 | 4679 | 4946 | 5275 | 5262 |
| Crude fiber, % | 2.0 | 2.5 | 6.0 | — | — | 2.3 | 2.8 | 6.9 | — | — |
| Ash, % | 1.5 | 7.1 | 5.6 | — | — | 1.8 | 8.1 | 6.4 | — | — |
| Calcium, % | 0.01 | 0.50 | 0.05 | — | — | 0.01 | 0.57 | 0.06 | — | — |
| Phosphorus, % | 0.25 | 0.67 | 0.78 | — | — | 0.29 | 0.76 | 0.89 | — | — |
| Arginine, % | 0.34 | 3.43 | 1.40 | — | — | 0.40 | 3.90 | 1.61 | — | — |
| Cystine, % | 0.15 | 0.73 | 0.54 | — | — | 0.18 | 0.83 | 0.62 | — | — |
| Lysine, % | 0.26 | 3.06 | 1.07 | — | — | 0.30 | 3.48 | 1.23 | — | — |
| Methionine, % | 0.14 | 0.72 | 0.55 | — | — | 0.16 | 0.82 | 0.63 | — | — |
| Threonine, % | 0.24 | 1.85 | 1.12 | — | — | 0.28 | 2.10 | 1.28 | — | — |
| Tryptophan, % | 0.06 | 0.67 | 0.23 | — | — | 0.06 | 0.76 | 0.26 | — | — |
| Alanine, % | 0.51 | 2.06 | 2.07 | — | — | 0.60 | 2.34 | 2.37 | — | — |
| Aspartic acid, % | 0.45 | 5.38 | 1.93 | — | — | 0.52 | 6.11 | 2.21 | — | — |
| Glutamic acid, % | 1.24 | 8.63 | 4.24 | — | — | 1.45 | 9.81 | 4.86 | — | — |
| Glycine, % | 0.28 | 2.02 | 1.29 | — | — | 0.32 | 2.30 | 1.48 | — | — |
| Histidine, % | 0.19 | 1.33 | 0.79 | — | — | 0.22 | 1.51 | 0.91 | — | — |
| Isoleucine, % | 0.25 | 2.10 | 1.10 | — | — | 0.29 | 2.39 | 1.26 | — | — |
| Leucine, % | 0.81 | 3.65 | 3.42 | — | — | 0.95 | 4.15 | 3.92 | — | — |
| Phenylalanine, % | 0.32 | 2.28 | 1.59 | — | — | 0.38 | 2.59 | 1.82 | — | — |
| Proline, % | 0.58 | 2.28 | 2.21 | — | — | 0.68 | 2.59 | 2.53 | — | — |
| Serine, % | 0.30 | 2.15 | 1.38 | — | — | 0.35 | 2.44 | 1.58 | — | — |
| Tyrosine, % | 0.22 | 1.66 | 1.15 | — | — | 0.26 | 1.89 | 1.32 | — | — |
| Valine, % | 0.32 | 2.26 | 1.44 | — | — | 0.38 | 2.57 | 1.65 | — | — |

¹Oil-DDGS mixture prepared from extracted DDGS (91.3%) and respective source oil (8.7%).

TABLE 2
Analyzed energy content of source oils and fatty acid profile
of selected ingredient sources used to prepare diets

| | Extracted | | | Corn Oil | HOS Oil |
|---|---|---|---|---|---|
| Item | DDGS | Corn Oil | HOS Oil | DDGS¹ | DDGS¹ |
| GE, cal/g | — | 9417 | 9461 | — | — |
| Fatty acid, % relative² | | | | | |
| 16:0 | 15.81 | 10.79 | 3.19 | 12.27 | 7.17 |
| 16:1 | 0.14 | 0.10 | 0.063 | 0.12 | 0.089 |
| 18:0 | 2.13 | 2.02 | 3.20 | 2.11 | 2.91 |
| 18:1 | 24.69 | 29.42 | 86.44 | 27.92 | 66.53 |
| 18:2 | 53.15 | 55.65 | 5.16 | 54.78 | 20.55 |
| Total CLA isomers | 0.058 | 0.01 | 0.02 | 0.003 | 0.029 |
| CLA_2 18:2³ | 0.007 | — | — | 0.000 | 0.003 |
| 10t12c 18:2 | 0.008 | — | — | 0.000 | 0.005 |
| 9t11t 18:2 | 0.042 | 0.01 | 0.02 | 0.003 | 0.021 |
| 18:3 | 1.92 | 0.94 | 0.000 | 1.22 | 0.69 |
| 20:1 | 0.025 | 0.17 | 0.12 | 0.18 | 0.15 |
| 22:1 | 0.007 | 0.004 | 0.000 | 0.008 | 0.007 |
| Other identified peaks⁴ | 0.89 | 0.78 | 1.48 | 0.89 | 1.41 |
| Iodine value⁵ | 119 | 124 | 83 | 122 | 95 |

¹Oil-DDGS mixture prepared from extracted DDGS (91.3%) and respective source oil (8.7%).
²Fatty acid relative percent calculated as (fatty acid peak area/total peak area) × 100.
³Unidentified isomer that elutes from column between 9c11t 18:2 and 10t12c 18:2.
⁴Other identified peaks = 12:0 + 13:0 + 14:0 + 14:1 + 15:0 + 17:0 + 20:0 + 20:2 + 20:4 + 20:5 + 22:0 + 22:3 + 22:5 + 24:0 + 24:1.
⁵Calculated iodine value (AOCS 1993).

### Example 2

### Demonstration that Cooked Meat Derived from Poultry Fed a High-Oleic DDGS Diet Exhibits Improved Oxidative Stability

Five dietary treatments were prepared using basal corn and soybean meal sources alone (Control, 0% DDGS) or in combination with two levels (15% or 30%) of DDGS with added corn oil (DDGS) or high-oleic sunflower oil (HODDGS). Each oil-DDGS mixture consisted of 91.3% extracted DDGS and 8.7% source oil. A three-phase feeding system was used in this trial: starter (days 0 to 21), grower (days 22 to 35), and finisher (days 36 to 49). Diets were formulated to meet NRC guidelines (9th edition, 1994; Table 3). Treatment diets were manufactured at the Pioneer Livestock Nutrition Center (Polk City, Iowa); ingredient compositions of the complete diets are presented in Table 4. The basal corn source was milled prior to diet preparation to meet an average particle size of 650 to 750 microns. Feed samples of each treatment were collected and submitted for determination of moisture, protein, fat, GE, crude fiber, ash, calcium, phosphorus, amino acid profile, and fatty acid profile.

TABLE 3
Diet formulation guidelines

| | Starter | Grower | Finisher |
|---|---|---|---|
| Nutrient | (Days 0-21) | (Days 22-35) | (Days 36-49) |
| AME (kcal/kg) | 2860 | 2926 | 2937 |
| Protein, % | 21.4 | 19.1 | 17.4 |
| Lysine, % | 1.20 | 1.07 | 0.94 |
| Methionine, % (min.) | 0.61 | 0.53 | 0.45 |
| Methionine + Cystine, % | 0.93 | 0.82 | 0.73 |
| Arginine, % | 1.30 | 1.16 | 1.07 |
| Threonine, % (min.) | 0.88 | 0.78 | 0.58 |
| Tryptophan, % | 0.24 | 0.20 | 0.16 |
| Total phosphorus, % (min.) | 0.73 | 0.65 | 0.62 |
| Available phosphorus, % | 0.42 | 0.39 | 0.36 |
| Total calcium, % (min.) | 0.88 | 0.86 | 0.91 |
| Dietary sodium, % | 0.20 | 0.20 | 0.20 |
| Dietary choline, % | 0.13 | 0.13 | 0.13 |

TABLE 4
Ingredient composition of diets

| | | | | | |
|---|---|---|---|---|---|
| | | 15% | 30% | 15% | 30% |
| Ingredient, % | Control | DDGS | DDGS | HODDGS | HODDGS |

Starter Phase, Days 0 to 21

| | | | | | |
|---|---|---|---|---|---|
| Basal corn | 58.977 | 47.535 | 40.708 | 47.535 | 40.708 |
| source | | | | | |
| Soybean meal | 34.466 | 33.247 | 25.002 | 33.247 | 25.002 |
| 47.5% | | | | | |
| Corn oil DDGS | — | 14.998 | 30.003 | — | — |
| HODDGS | — | — | — | 14.998 | 30.003 |
| Soybean hulls | 2.001 | — | — | — | — |
| Dical Phosphate | 1.616 | 1.260 | 0.950 | 1.260 | 0.950 |
| Limestone | 1.336 | 1.530 | 1.655 | 1.530 | 1.655 |
| Salt | 0.520 | 0.500 | 0.500 | 0.500 | 0.500 |
| DL Methionine | 0.276 | 0.199 | 0.201 | 0.199 | 0.201 |
| L-Lysine-HCL | 0.092 | 0.073 | 0.256 | 0.073 | 0.256 |
| L-Threonine | 0.074 | 0.027 | 0.072 | 0.027 | 0.072 |
| L-Tryptophan | 0.018 | 0.008 | 0.028 | 0.008 | 0.028 |
| Poultry VTM | 0.625 | 0.625 | 0.625 | 0.625 | 0.625 |

Grower Phase, Days 22 to 35

| | | | | | |
|---|---|---|---|---|---|
| Basal corn | 65.269 | 54.632 | 47.779 | 54.632 | 47.779 |
| source | | | | | |
| Soybean meal | 28.695 | 26.254 | 18.046 | 26.254 | 18.046 |
| 47.5% | | | | | |
| Corn oil DDGS | — | 15.002 | 29.994 | — | — |
| HODDGS | — | — | — | 15.002 | 29.994 |
| Soybean hulls | 1.600 | — | — | — | — |
| Dical Phosphate | 1.485 | 1.135 | 0.830 | 1.135 | 0.830 |
| Limestone | 1.385 | 1.510 | 1.635 | 1.510 | 1.635 |
| Salt | 0.520 | 0.500 | 0.500 | 0.500 | 0.500 |
| DL Methionine | 0.230 | 0.172 | 0.174 | 0.172 | 0.174 |
| L-Lysine-HCL | 0.115 | 0.130 | 0.312 | 0.130 | 0.312 |
| L-Threonine | 0.067 | 0.036 | 0.081 | 0.036 | 0.081 |
| L-Tryptophan | 0.010 | 0.005 | 0.026 | 0.005 | 0.026 |
| Poultry VTM | 0.625 | 0.625 | 0.625 | 0.625 | 0.625 |

Finisher Phase, Days 36 to 49

| | | | | | |
|---|---|---|---|---|---|
| Basal corn | 68.083 | 58.192 | 49.287 | 58.192 | 49.287 |
| source | | | | | |
| Soybean meal | 25.697 | 22.051 | 16.948 | 22.051 | 16.948 |
| 47.5% | | | | | |
| Corn oil DDGS | — | 15.001 | 29.997 | — | — |
| HODDGS | — | — | — | 15.991 | 29.997 |
| Soybean hulls | 1.900 | 0.700 | — | 0.700 | — |
| Dical Phosphate | 1.395 | 1.055 | 0.720 | 1.055 | 0.720 |
| Limestone | 1.550 | 1.600 | 1.600 | 1.600 | 1.600 |
| Salt | 0.520 | 0.540 | 0.500 | 0.540 | 0.500 |
| DL Methionine | 0.161 | 0.131 | 0.118 | 0.131 | 0.118 |
| L-Lysine-HCL | 0.050 | 0.100 | 0.191 | 0.100 | 0.191 |
| L-Threonine | 0.021 | 0.005 | 0.009 | 0.005 | 0.009 |
| L-Tryptophan | — | — | 0.007 | — | 0.007 |
| Poultry VTM | 0.625 | 0.625 | 0.625 | 0.625 | 0.625 |

Newly hatched male broilers of a commercial strain were obtained in sufficient numbers to assure availability of 100 healthy chicks. Chicks were evaluated upon receipt for overall health, signs of disease, or other complications that might affect the outcome of the study. Birds were weighed, wing-banded for identification purposes, and randomly placed into floor pens (20 broilers per pen) upon receipt (Day 0). Birds were housed in a facility with forced air heaters and heat lamps. A continuous (24 hour) lighting program for broilers was followed.

Pens were randomly assigned to the dietary treatments (1 pen per treatment). All diets were fed in mash form, with diets and water provided ad libitum. Birds were fed their respective diets for a total of 49 days, with treatments initiated on Jul. 17, 2008, and terminated on Sep. 4, 2008. Birds were weighed on days 0, 21 and 49, and feed efficiencies were calculated for the overall feeding period (Days 0 through 49). Birds were observed for any changes in health or behavior; animals found dead or moribund underwent a complete necropsy examination to determine cause of death. Birds were sacrificed at the end of the 49-day feeding period by cervical dislocation.

Whole boneless breasts and thighs from both sides of each bird were collected at the time of harvest and sent to Pioneer for meat quality analysis; abdominal fat pads were also collected from each bird. Determination of warmed-over flavor as indicated by thiobarbituric reactive substance (TBARs) analysis was performed on freshly cooked and warmed-over (24 hours) breast and thigh samples. Raw breast and thigh samples, along with abdominal fat pad samples, were analyzed for fatty acid profile.

Growth performance data were not analyzed due to the lack of replication. Individual tissue yield (breast, thigh, abdominal fat), TBARs, and fatty acid data were analyzed using the MIXED Procedure of SAS. The individual bird was considered to be the experimental unit. The model for data analysis consisted of treatment as a fixed effect; bird (treatment) was included as a random effect in the analysis of fatty acid data, whereas date of analysis was included as a random effect in the TBARs data analysis. Linear and quadratic effects (0%, 15%, and 30%) of DDGS and HODDGS addition were also determined. An additional comparison of Control versus DDGS or HODDGS addition was also included.

Growth performance data are summarized in Table 5; data were not statistically analyzed due to the lack of replication. Breast and thigh meat yields, along with abdominal fat yield, were not different between treatment groups (Table 6). No significant (P<0.05) linear or quadratic effects were noted for DDGS or HODDGS groups, although a trend (P=0.0896) for increased fat yield with HODDGS was observed. Overall, DDGS and HODDGS addition did not affect tissue yields.

TABLE 5

| | | 15% | 30% | 15% | 30% |
|---|---|---|---|---|---|
| Item | Control | DDGS | DDGS | HODDGS | HODDGS |
| Day 0 body | 48.4 | 48.0 | 48.3 | 48.0 | 48.6 |
| weight, g | | | | | |
| Day 49 body | 2400.4 | 2391.0 | 2385.8 | 2415.2 | 2428.3 |
| weight, g | | | | | |
| Total weight | 2352.0 | 2343.0 | 2337.5 | 2367.2 | 2379.6 |
| gain, g | | | | | |
| Mortality, % | 10.00 | 5.00 | 5.00 | 5.00 | 10.00 |
| Feed:gain, g | 1.942 | 1.946 | 1.972 | 1.950 | 1.941 |
| feed/g gain | | | | | |

TABLE 6
Effect of dietary treatment on tissue yields¹

| | | | | | | | | DDGS | | HODDGS | |
|---|---|---|---|---|---|---|---|---|---|---|---|
| | | 15% | 30% | 15% | 30% | | | Linear | Quadratic | Linear | Quadratic |
| Item | Control | DDGS | DDGS | HODDGS | HODDGS | SEM | P value | Effect | Effect | Effect | Effect |
| Breast | 19.28 | 19.16 | 19.30 | 19.16 | 19.29 | 0.19 | 0.96 | 0.65 | 0.79 | 0.98 | 0.95 |
| Thigh | 11.20 | 11.26 | 11.47 | 11.16 | 11.66 | 0.19 | 0.30 | 0.89 | 0.72 | 0.0896 | 0.87 |
| Abdominal fat | 1.03 | 1.02 | 1.05 | 1.07 | 1.05 | 0.06 | 0.99 | 0.68 | 0.73 | 0.85 | 0.86 |

¹Treatment means not different (P > .05).

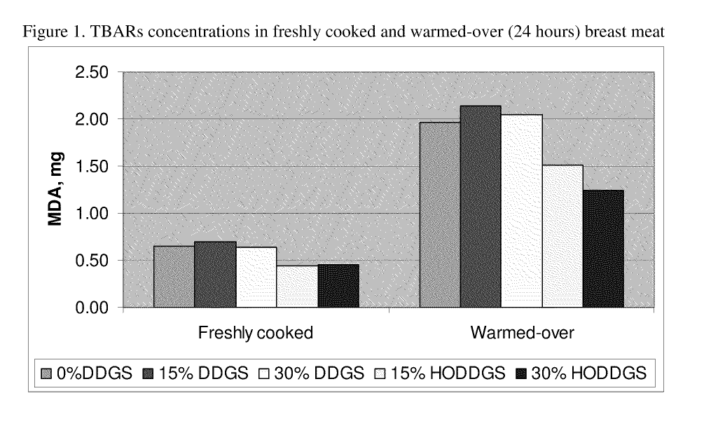

Concentrations of TBARs (Table 7) in freshly cooked breast meat were higher (P<0.05) for the Control and 15% DDGS groups as compared to the 30 and 15% HODDGS groups; values for the latter group were also lower as compared to the 30% DDGS group. Warmed-over TBARs values were also reduced for the 15 and 30% HODDGS groups as compared to the other groups. A significant linear effect on both freshly cooked and warmed-over breast meat was noted for HODDGS addition. Freshly cooked and warmed-over thigh TBARs values were observed in the order of 15% DDGS and 30% DDGS >15% HODDGS and Control >30% HODDGS. Linear and quadratic effects (P<0.05) of DDGS addition were noted for both sample types. Linear effects (P<0.05) of HODDGS addition were noted for both freshly cooked and warmed-over thigh meat, and a quadratic effect (P<0.05) observed for warmed-over thigh meat only. Results are also presented in FIGS. 1 (breast meat) and 2 (thigh meat). In overall comparison to the Control group, HODDGS addition reduced TBARs values for breast meat, while DDGS addition resulted in higher TBARs values for thigh meat (Table 8).

TABLE 7
Effect of dietary treatment on TBARS concentrations in freshly
cooked and warmed-over (24 hours) breast and thigh meat¹

| | | | | | | | | DDGS | | HODDGS | |
|---|---|---|---|---|---|---|---|---|---|---|---|
| | | 15% | 30% | 15% | 30% | | | Linear | Quadratic | Linear | Quadratic |
| Item | Control | DDGS | DDGS | HODDGS | HODDGS | SEM | P value | Effect | Effect | Effect | Effect |

Breast

| | | | | | | | | | | | |
|---|---|---|---|---|---|---|---|---|---|---|---|
| Freshly | 0.65^{a} | 0.70^{a} | 0.64^{ab} | 0.44^{c} | 0.45^{bc} | 0.07 | 0.0171 | 0.87 | 0.50 | 0.442 | 0.18 |
| cooked | | | | | | | | | | | |
| Warmed | 1.97^{a} | 2.14^{a} | 2.05^{a} | 1.51^{b} | 1.25^{b} | 0.33 | 0.0003 | 0.71 | 0.50 | 0.0020 | 0.62 |
| over | | | | | | | | | | | |

Thigh

| | | | | | | | | | | | |
|---|---|---|---|---|---|---|---|---|---|---|---|
| Freshly | 1.71^{b} | 2.85^{a} | 2.52^{a} | 1.73^{b} | 1.25^{c} | 0.51 | <0.0001 | 0.0003 | 0.0001 | 0.0340 | 0.16 |
| cooked | | | | | | | | | | | |
| Warmed | 5.19^{b} | 8.24^{a} | 7.83^{a} | 5.84^{b} | 4.26^{c} | 0.44 | <0.0001 | <0.0001 | <0.0001 | 0.0371 | 0.0038 |
| over | | | | | | | | | | | |

TABLE 8
Effect of DDGS or HODDGS addition on TBARs
concentrations in freshly cooked and warmed-over
(24 hours) breast and thigh meat¹

| | | | | | |
|---|---|---|---|---|---|
| | | | | Control vs | Control vs |
| Item | Control | DDGS | HODDGS | DDGS | HODDGS |

Breast

| | | | | | |
|---|---|---|---|---|---|
| Freshly | 0.65 | 0.67 | 0.45 | 0.85 | 0.0165 |
| cooked | | | | | |
| Warmed- + | 1.97 | 2.09 | 1.38 | 0.51 | 0.0033 |
| over | | | | | |

Thigh

| | | | | | |
|---|---|---|---|---|---|
| Freshly | 1.71 | 2.68 | 1.49 | <0.0001 | 0.24 |
| cooked | | | | | |
| Warmed | 5.19 | 8.03 | 5.05 | <0.0001 | 0.70 |
| over | | | | | |

### Example 3

### Demonstration that Cooked Meat Derived from Cattle Fed a High-Oleic DG Diet Exhibits Improved Oxidative Stability

Eight yearling Angus steers (approximately 400 kg initial weight) are given free choice access to test diets for a feeding trial lasting 84 days. Steers are fed using a Calan gate system whereby feed access is restricted to a single steer that permits daily feed intake to be measured for each individual steer. Four steers within one pen are fed a control diet containing commodity corn distiller's grain plus solubles (DDGS) whereas the other four steers housed in an adjacent pen in the same barn are fed a test diet containing a mixture simulating the fatty acid composition of HODDGS (DDGS prepared as described in Example 1) that consist of a mixture of 88% fat-extracted distiller's dried corn grain with 12% high-oleic sunflower oil (Table 9). With daily feed intake averaging 10 kg, this requires 6720 kg of feed (including 1344 kg of test product). Feed delivery and refusals are measured each day whereas dry matter content of feed and body weight of each steer is measured monthly. Rate of gain and gain to feed ratio, an index of efficiency of feed use, is calculated. At the end of the feeding trial, longissimus muscles will be recovered from each carcass 24 hours after slaughter for measurement of meat quality. Quality indices include visual color appraisal, quantitative color appraisal (L, a*, b* readings with a Minolta color camera), and TBARS of muscle tissue. Color appraisals are performed daily whereas TBARS is measured for samples on days 6 and 7 of the 7-day shelf-life experiment. In the shelf-life experiment, film-covered longissimus steaks (2 cm thick) are exposed in a display counter with lighting and temperature characteristic of a meat display case at a supermarket. Statistical analysis of dietary treatment on dry matter intake, rate of gain and feed efficiency during each 28-day period and for the total trial and on meat quality considers each animal as an experimental unit.

TABLE 9
Composition of diets for steers, % of diet dry matter

| Component | Control diet | Test diet |
|---|---|---|
| Corn grain, dry rolled | 36 | 36 |
| Normal DDG S | 40 | 0 |
| Modified (HO) DDGS¹ | 0 | 40 |
| Alfalfa silage | 19 | 19 |
| Supplement² | 5 | 5 |

¹A mixture that simulates the fatty acid and nutrient composition of DDGS from high-oleic corn grain that consists of 88% fat-extracted corn distiller's dried grains with solubles and 12% high-oleic sunflower oil.
²Supplement provides protein, vitamins, and minerals.)

### Example 4

### Demonstration that Milk Derived from Cattle Fed a High-Oleic DG Diet Exhibits Improved Oxidative Stability

Four lactating multiparous Holstein cows starting about 120 days following parturition are individually fed test diets during two-week periods within a 4-week trial using a crossover experimental design wherein two cows are fed each diet during the first period, and each cow is fed the alternate diet during the second two week period. The two test diets include a control diet with 20% of dry matter from typical corn distiller's dried grains and a test diet that is isonitrogenous and isocaloric where a mixture of 88% defatted corn germ plus 12% high-oleic sunflower oil replace the typical corn distiller's dried grain in the diet (Table 10). At 25 kg daily dry matter intake, this experiment requires 2800 kg of feed (including 280 kg of test product). Dry matter intake and milk production are measured daily. Milk fat content, milk fat iodine number, and oxidative stability is measured using a single milk sample from each cow during each period consisting of a proportional composite of milk obtained at both the am and pm milking on the final two days of each period. As an index of oxidative stability of milk, samples from each cow during each period are assayed for lipid hydroperoxides and hexanol content following 0, 2, 4, 6, and 24 days of exposure to fluorescent light (2,000 lx) as described by Havemose et al. (J. Dairy Sci. 89:1970-1980; 2006). Statistical responses in dry matter intake, milk production, milk composition, and oxidative stability of milk consider effects of period and diet; cow within diet and period are considered to be the experimental unit.

TABLE 10
Composition of diets for cows, % of diet dry matter

| Component | Control diet | Test diet |
|---|---|---|
| Typical DDGS | 20 | 0 |
| Modified (HO) DDGS¹ | 0 | 20 |
| Alfalfa silage | 28 | 28 |
| Corn silage | 30 | 30 |
| Supplement² | 16 | 16 |

¹A mixture that simulates the fatty acid and nutrient composition of DDGS from high-oleic corn grain that consists of 88% fat-extracted corn distiller's dried grains with solubles and 12% high-oleic sunflower oil.
²Supplement provides protein, vitamins, and minerals.

### Example 5

### Demonstration that Cooked Meat Derived from Swine Fed a High-Oleic DG Diet Exhibits Improved Oxidative Stability

Seventy-two barrows (approximately 16 to 20 kg) were transported to the Pioneer Livestock Nutrition Center (Polk City, Iowa), weighed and randomly placed into individual pens (0.76×1.65 m) with water and feed provided ad libitum. Pigs were fed a common commercial diet containing Tylan® for a 7 to 10 day adaptation period; the average weight at the initiation of the experimental period was 21 kg.

Commodity DDGS material was shipped to the TAMU Food Protein Research and Development Center (College Station, Tex.) where it was processed to reduce its oil content. The material underwent hexane extraction at 125° F. for one-hour followed by air-drying at ambient temperatures. The extracted DDGS material was shipped back to Pioneer for use in diet preparation. Oil-DDGS mixtures consisting of 91.86% DDGS and 8.14% source oil were prepared using DDGS and corn oil (CO) or high-oleic (HO) sunflower oil. Samples of CODDGS and HODDGS mixtures were submitted for the following analyses: proximate (dry matter, crude protein, crude fat [ether extract], and crude fiber), gross energy (GE), ash, mineral (calcium and phosphorus), amino acid profile, and fatty acid profile. Corn sources (basal corn and HO corn) were ground to a consistent geometric mean particle size (550 to 650 microns). Samples of soybean meal, basal corn, and HO corn were submitted for proximate, GE, ash, mineral, and amino acid profile analyses; corn sources were also analyzed for fatty acid profile. Nutrient analytical results (Tables (11) and (12)) were utilized in diet formulation.

TABLE 11
Analyzed nutrient composition of ingredient sources
used to prepare diets (All values on an as-is basis.)

| | Soybean | Basal | HO | | |
|---|---|---|---|---|---|
| Nutrient | Meal | Corn | Corn | CODDGS¹ | HODDGS¹ |
| Lot ID | SBM07- | F09CN- | R08CN-099- | — | — |
| | ERH-01 | HL-01 | US-5299 | | |
| Moisture, % | 10.9 | 13.5 | 16.8 | 9.8 | 9.8 |
| Protein, % | 47.0 | 6.5 | 6.8 | 24.4 | 24.4 |
| Fat, % | 1.6 | 3.7 | 3.3 | 12.4 | 12.9 |
| GE, cal/g | 4143 | 3830 | 3705 | 4750 | 4764 |
| Crude fiber, % | 4.1 | 1.8 | 2.1 | 6.9 | 7.4 |
| Ash, % | 6.4 | 1.1 | 1.0 | 4.2 | 4.1 |
| Calcium, % | 0.37 | 0.01 | 0.02 | 0.03 | 0.03 |
| Phosphorus, % | 0.69 | 0.23 | 0.20 | 0.81 | 0.81 |
| Arginine, % | 3.30 | 0.32 | 0.31 | 1.11 | 1.11 |
| Cystine, % | 0.66 | 0.14 | 0.15 | 0.49 | 0.49 |
| Lysine, % | 2.98 | 0.24 | 0.23 | 0.73 | 0.75 |
| Methionine, % | 0.64 | 0.13 | 0.15 | 0.47 | 0.48 |
| Threonine, % | 1.71 | 0.23 | 0.24 | 0.89 | 0.90 |
| Tryptophan, % | 0.63 | 0.05 | 0.05 | 0.21 | 0.21 |
| Alanine, % | 1.96 | 0.47 | 0.49 | 1.64 | 1.67 |
| Aspartic acid, % | 5.15 | 0.44 | 0.46 | 1.52 | 1.54 |
| Glutamic acid, % | 7.99 | 1.13 | 1.15 | 3.10 | 3.08 |
| Glycine, % | 1.91 | 0.27 | 0.25 | 0.97 | 0.99 |
| Histidine, % | 1.29 | 0.20 | 0.19 | 0.69 | 0.71 |
| Isoleucine, % | 2.18 | 0.23 | 0.21 | 0.98 | 1.02 |
| Leucine, % | 3.58 | 0.74 | 0.77 | 2.78 | 2.84 |
| Phenylalanine, % | 2.35 | 0.31 | 0.30 | 1.20 | 1.25 |
| Proline, % | 2.09 | 0.60 | 0.57 | 1.77 | 1.83 |
| Serine, % | 1.93 | 0.28 | 0.31 | 1.01 | 0.98 |
| Tyrosine, % | 1.69 | 0.18 | 0.21 | 0.85 | 0.87 |
| Valine, % | 2.24 | 0.32 | 0.29 | 1.29 | 1.33 |

¹Oil-DDGS mixture prepared from extracted DDGS (91.86%) and respective source oil (8.14%).

TABLE 12
Analyzed fatty acid profiles of ingredient
sources used to nrepare diets

| Fatty acid, % | | | | |
|---|---|---|---|---|
| relative¹ | Basal Corn | HO Corn | CODDGS | HODDGS |
| 16:0 | 11.7 | 12.4 | 11.3 | 5.10 |
| 16:1 | 0.10 | 0.25 | 0.20 | 0.20 |
| 18:0 | 1.9 | 1.85 | 1.80 | 2.93 |
| 18:1 | 27.9 | 59.3 | 27.6 | 72.6 |
| 18:2 | 57.2 | 25.2 | 58.1 | 18.4 |
| 18:3 | 1.28 | 1.00 | 1.20 | 0.65 |

¹Fatty Acid relative percent calculated as (fatty acid peak area/total peak area) × 100.

Seven dietary treatments were prepared using basal corn and soybean meal sources alone (Control, 0% DDGS) or in combination with three levels (10%, 20% or 30%) of extracted DDGS with added corn oil (CODDGS) or high-oleic sunflower oil (HODDGS).

An eighth treatment was prepared using HO corn and soybean meal in combination with 30% HODDGS (HO corn+30% HODDGS). Treatments were randomly allotted to pens (9 pens per treatment) with consideration for equalizing weight across treatments.

Diets were prepared at the Pioneer Livestock Nutrition Center (Polk City, Iowa). A three-phase feeding program was used with grower diets fed from 25 to 60 kg (Grower), early finisher diets fed from 60 to 90 kg (Finisher 1), and late finisher diets fed from 90 to 115 kg (Finisher 2). Ingredient compositions of the diets are presented by phase in Table 13. Balanced diets were formulated according to National Research Council (NRC) guidelines (“Nutrient Requirements of Swine”, 9th Revised Edition, 1998). All diets were balanced to have the same amino acid/energy ratio, and for sulfur amino acids (methionine and cystine), lysine, threonine, and tryptophan. No antibiotics were added to the diets during the three phases. Composite samples of each treatment were collected at the time of diet preparation and submitted for nutrient analysis (proximates, GE, ash, mineral, amino acid profile, and fatty acid profile).

TABLE 13
Ingredient composition of individual phase diets

| | | | | | | | | |
|---|---|---|---|---|---|---|---|---|
| | | | | | | | | HO Corn + |
| | | 10% | 20% | 30% | 10% | 20% | 30% | 30% |
| Ingredient, % | Control | CODDGS | CODDGS | CODDGS | HODDGS | HODDGS | HODDGS | HODDGS |

Grower, 25 to 60 kg

| | | | | | | | | |
|---|---|---|---|---|---|---|---|---|
| Basal corn | 75.89 | 66.82 | 57.74 | 48.65 | 66.82 | 57.74 | 48.65 | — |
| HO corn | — | — | — | — | — | — | — | 48.28 |
| SBM | 20.77 | 19.95 | 19.13 | 18.31 | 19.95 | 19.13 | 18.32 | 18.81 |
| CODDGS | — | 10.00 | 20.00 | 30.00 | — | — | — | — |
| HODDGS | — | — | — | — | 10.00 | 20.00 | 30.00 | 30.00 |
| Limestone | 0.97 | 1.14 | 1.31 | 1.47 | 1.13 | 1.30 | 1.46 | 1.37 |
| DiCal 18.5% P | 0.99 | 0.77 | 0.55 | 0.33 | 0.78 | 0.56 | 0.34 | 0.34 |
| Salt | 0.50 | 0.50 | 0.50 | 0.50 | 0.50 | 0.50 | 0.50 | 0.50 |
| ADM Swine VTM | 0.50 | 0.50 | 0.50 | 0.50 | 0.50 | 0.50 | 0.50 | 0.50 |
| L-Lysine 98% | 0.21 | 0.21 | 0.21 | 0.21 | 0.21 | 0.21 | 0.21 | 0.19 |
| L-Threonine | 0.10 | 0.08 | 0.05 | 0.03 | 0.08 | 0.05 | 0.03 | 0.02 |
| DL-Methionine 99 | 0.06 | 0.04 | 0.01 | — | 0.03 | 0.01 | — | — |

Finisher 1, 60 to 90 kg

| | | | | | | | | |
|---|---|---|---|---|---|---|---|---|
| Basal corn | 76.46 | 67.56 | 58.66 | 49.72 | 67.56 | 58.66 | 49.72 | — |
| HO corn | — | — | — | — | — | — | — | 50.15 |
| SBM | 20.60 | 19.60 | 18.61 | 17.62 | 19.60 | 18.61 | 17.62 | 17.26 |
| CODDGS | | 10.00 | 20.00 | 30.00 | — | — | — | — |
| HODDGS | — | — | — | — | 10.00 | 20.00 | 30.00 | 30.00 |
| Limestone | 0.89 | 1.06 | 1.24 | 1.41 | 1.06 | 1.23 | 1.40 | 1.34 |
| DiCal 18.5% P | 0.79 | 0.56 | 0.34 | 0.11 | 0.56 | 0.34 | 0.12 | 0.12 |
| Salt | 0.50 | 0.50 | 0.50 | 0.50 | 0.50 | 0.50 | 0.50 | 0.50 |
| ADM Swine VTM | 0.50 | 0.50 | 0.50 | 0.50 | 0.50 | 0.50 | 0.50 | 0.50 |
| L-Lysine 98% | 0.13 | 0.13 | 0.13 | 0.13 | 0.13 | 0.13 | 0.13 | 0.13 |
| L-Threonine | 0.07 | 0.05 | 0.02 | — | 0.05 | 0.02 | — | — |
| DL-Methionine 99 | 0.06 | 0.03 | 0.005 | — | 0.03 | 0.002 | — | — |

Finisher 2, 90 to 115 kg

| | | | | | | | | |
|---|---|---|---|---|---|---|---|---|
| Basal corn | 83.01 | 74.15 | 65.25 | 56.33 | 74.14 | 65.25 | 56.33 | — |
| HO corn | — | — | — | — | — | — | — | 56.68 |
| SBM | 14.20 | 13.16 | 12.13 | 11.11 | 13.17 | 12.14 | 11.11 | 10.83 |
| CODDGS | | 10.00 | 20.00 | 30.00 | — | — | — | — |
| HODDGS | — | — | — | — | 10.00 | 20.00 | 30.00 | 30.00 |
| Limestone | 0.84 | 1.02 | 1.19 | 1.36 | 1.01 | 1.18 | 1.35 | 1.28 |
| DiCal 18.5% P | 0.74 | 0.52 | 0.29 | 0.07 | 0.52 | 0.30 | 0.08 | 0.07 |
| Salt | 0.50 | 0.50 | 0.50 | 0.50 | 0.50 | 0.50 | 0.50 | 0.50 |
| ADM Swine VTM | 0.50 | 0.50 | 0.50 | 0.50 | 0.50 | 0.50 | 0.50 | 0.50 |
| L-Lysine 98% | 0.13 | 0.13 | 0.13 | 0.13 | 0.13 | 0.13 | 0.13 | 0.13 |
| L-Threonine | 0.05 | 0.02 | — | — | 0.02 | — | — | — |
| DL-Methionine 99 | 0.03 | — | — | — | — | — | — | — |

Animals were monitored two times daily for overall health and signs of sickness; those that appeared to be sick were treated per the directions of the attending veterinarian. Postmortem examinations were performed as needed and copies of necropsy reports were provided. One mortality occurred in the 30% HODDGS group; the cause of death was not treatment-related but was determined to be due to toxemia secondary to colonic ulceration, infection, and inflammation. Observations on pig health, treatments given, morbidities and mortalities were recorded. Pigs were weighed at treatment initiation (day 0) and every 14 days thereafter to calculate total body weight gain and average daily gain (ADG). Feed addition and refusal weights were recorded to calculate average daily feed (ADF) and feed efficiency.

The average weight of the first harvest group at day 76 (Nov. 2, 2009) was 107 kg and the average weight of the second harvest group at day 90 (Nov. 16, 2009) was 112 kg. Harvest occurred at the University of Missouri (Columbia) abattoir. Standard carcass measurements, including hot carcass weight (HCW), loineye area, and fat depth were recorded on the day of slaughter. Intramuscular ham (semimembranosus) and loin (juncture of the 10th/11th rib) pH was recorded at 45 minutes postmortem. Following a 24 hour chill at approximately 0° C., 24-hour pH was measured at the 10th rib with a Mettler Toledo (Columbus, Ohio) glass penetration pH.

Carcasses were transferred to the University of Missouri processing lab. The right side of the carcass was fabricated into primal cuts, and ham, loin, Boston butt, picnic, and belly cuts were used for meat quality evaluation. Cut weights were recorded and yields calculated. Belly firmness was evaluated as the amount of vertical and lateral “flex” and Iodine Values were calculated using a standard formula (AOCS Method cd 1c-85).

### SUMMARY

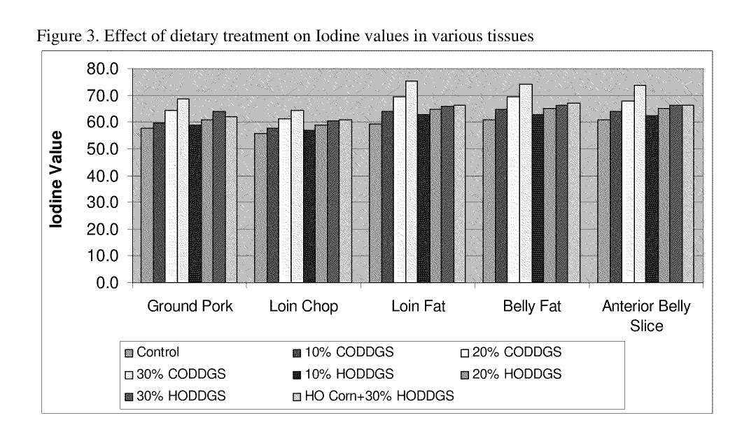

Growth performance was unaffected (P>0.05) by dietary treatment or DDGS source. Dietary treatment effects (P<0.05) on carcass measures were limited to belly firmness, last rib fat thickness, ham 24 hour pH, and loin 24 hour temperature. CODDGS addition decreased (P<0.05) belly firmness and last rib fat thickness. Individual carcass cut weights and yields were not different between diet groups, nor were they affected by DDGS source. Linear effects (P<0.05) of CODDGS or HODDGS addition on 18:1, 18:2, and Iodine Value were observed in most tissues. DDGS addition, regardless of source, resulted in higher Iodine Values for all tissues evaluated (see FIG. 3).

Other modifications and alternative embodiments of the invention are contemplated which do not depart from the scope of the invention as defined by the foregoing teachings and appended claims. It is intended that the claims cover all such modifications that fall within their scope.

All percentages recited refer to weight percent on a dry matter basis.

We claim:

1. A method of improving the quality of an animal product, comprising feeding the animal a diet comprising from about 5% to 40% high oleic distillers grain (HODG), wherein oleic acid comprises from at least about 55% to 87% of the fatty acid fraction of the DG.

2. The diet of the method of claim 1 wherein oleic acid comprises from about 60% to 75% of the fatty acid fraction of the DG.

3. The diet of the method of claim 1 wherein the amount of HODG is from about 10% to 50% of the diet.

4. The diet of the method of claim 1 wherein the product is meat and the quality of the meat is measured by criteria selected from the group consisting of increased pH, improved color value, improved oxidative stability, increased carcass firmness, and reduced purge.

5. The method of claim 1 wherein the product is milk and the quality is measured by hydroperoxide accumulation.

6. The method of claim 1 wherein the animal is poultry.

7. The method of claim 1 wherein the animal is a ruminant.

8. An animal diet for improving the quality of an animal product, comprising from about 5% to 50% high-oleic distillers grain (HODG), wherein oleic acid comprises from at least about 55% to 87% of the fatty acid fraction of the HODG.

9. The diet of claim 8 wherein the oleic acid comprises from about 60% to 75% of the fatty acid fraction of the DG.

10. The diet of claim 8 wherein the amount of HODG is from about 10% to 30% of the diet.

11. The diet of claim 8 wherein the product is meat and the quality of the meat is measured by criteria selected from the group consisting of increased pH, improved color value, improved oxidative stability, increased carcass firmness, and reduced purge.

12. The diet of claim 8 wherein the product is milk and the quality is measured by hydroperoxide accumulation.

13. The diet of claim 8 wherein the animal is poultry.

14. The diet of claim 8 wherein the animal is a ruminant.

15. A method of improving the quality of an animal product, comprising feeding the animal a diet comprising distillers grains (DG), and a source of supplemental oleic fatty acid, wherein oleic acid comprises from at least about 55% to 87% of the final fatty acid fraction of the diet.

16. The method of claim 15 wherein oleic acid comprises from at least about 60% to about 75% of the final fatty acid fraction of the diet.

17. The method of claim 15 wherein the source of supplemental oleic acid is selected from the group consisting of: high-oleic corn, high-oleic corn oil, high-oleic sunflower oil, or high oleic safflower oil.

18. The method of claim 15 wherein DG comprises from at least about 5% to 50% of the diet.

19. The method of claim 18 wherein DG comprises from at least about 10% to about 30% of the diet.

20. The method of claim 19 wherein DG comprises from at least 10% to about 15% of the diet.

21. The method of claim 15 wherein the product is meat and the quality of the meat is measured by criteria selected from the group consisting of: increased pH, improved color value, improved oxidative stability, increased carcass firmness, and reduced purge.

22. The method of claim 15 wherein the product is milk and the quality is measured by hydroperoxide accumulation.

23. The method of claim 15 wherein the animal is poultry.

24. The method of claim 15 wherein the animal is a ruminant.

25. A diet for improving the quality of an animal product, comprising distillers grains (DG), and a source of supplemental oleic fatty acid, wherein oleic acid comprises from at least about 55% to 87% of the final fatty acid fraction of the diet.

26. The diet of claim 25 wherein oleic acid comprises from at least about 60% to about 75% of the final fatty acid fraction of the diet.

27. The diet of claim 25 wherein the source of supplemental oleic acid is selected from the group consisting of: high-oleic corn, high-oleic corn oil, high-oleic sunflower oil, or high oleic safflower oil.

28. The diet of claim 25 wherein DG comprises from at least about 5% to 40% of the diet.

29. The diet of claim 28 wherein DG comprises from at least about 10% to about 30% of the diet.

30. The diet of claim 29 wherein DG comprises from at least 10% to about 15% of the diet.

31. The diet of claim 25 wherein the product is meat and the quality of the meat is measured by criteria selected from the group consisting of: increased pH, improved color value, improved oxidative stability, increased carcass firmness, and reduced purge.

32. The diet of claim 25 wherein the product is milk and the quality is measured by hydroperoxide accumulation.

33. The diet of claim 25 wherein the animal is poultry.

34. The diet of claim 25 wherein the animal is a ruminant.

35. The diet of claim 25 wherein the diet includes an effective amount of antioxidant, wherein the antioxidant is selected from the group consisting of: ATA, GT, tocotrienols, and mixtures thereof.

36. A diet for improving the carcass firmness as measured by iodine value (IV) of a pork meat product, the diet comprising from about 20% to about 30% distillers grain (DG) and a source of supplemental oleic acid, wherein oleic acid comprises from at least about 55% to about 75% of the final fatty acid fraction of the diet.
